(19) United States
(12) Patent Application Publication
(10) Pub. No.: US 2005/0114060 A1
(43) Pub. Date: May 26, 2005

(54) On-line fluid monitoring that compensates for a fluid's temperature dependance

(75) Inventors: David B. Skursha, Mentor, OH (US); Frederick P. Boyle, Kirtland, OH (US); Frank V. Zalar, Novelty, OH (US); Vadim F. Lvovich, Cleveland Hts., OH (US)

Correspondence Address: THE LUBRIZOL CORPORATION;Patent Administrator - Mail Drop 022B, 29400 Lakeland Boulevard, Wickliffe, OH, 44092-2298, US

(73) Assignee: The Lubrizol Corpration, Wickliffe, OH (US)

(21) Appl. No.: 10/700,207

(22) Filed: Nov. 3, 2003

(51) Int. Cl. G01K 15/00

(52) U.S. Cl. 702/99; 324/707

(57) ABSTRACT

A method for temperature compensating data relevant to the quality and/or condition of a fluid in use in transportation and industrial devices and/or processes. The method includes collecting and determining the temperature dependence of fluid quality and/or condition relevant data from a first fluid threshold temperature to at least a second fluid threshold temperature when change of fluid temperature is equal or greater than a preset rate, and using the determined dependence to compensate the relevant data to a standard temperature while the fluid is in use.

### BACKGROUND OF THE INVENTION

The present invention relates to on-line monitoring and analysis of a fluid, either liquid or gas, that varies in temperature. More specifically, this invention relates to a cost-effective method for temperature-compensating data relevant to temperature-sensitive fluid-properties, which are used to monitor and analyze fluid quality and/or condition, e.g. type or changes in base fluid, amount or depletion of a performance additive, type or amount of contamination, general degradation due to chemical breakdown, during equipment use and the like.

Fluids are a critical component for the proper operation of many types of devices and/or processes. For example: lubricants are needed for an internal combustion engine to efficiently provide power over a long service life, and metal working fluid is needed in machining equipment for rapid metal removal and maximum tool life. Optimum performance is achieved when the fluid in question is of a proper quality for the application. For a particular application, a fluid preferably includes an appropriate base fluid and proper performance additives, e.g. corrosion inhibitors, friction modifiers, dispersants, surfactants, detergents, and the like. During use or consumption, a fluid's condition should remain within determined limits, that is, chemical and/or other fluid changes should be within proper performance specifications.

Often device owners and/or process operators depend on suppliers to provide proper quality fluids and depend on regular level checks and fluid replacement to maintain proper fluid condition. The foregoing, however, is limited and does not provide protection against accidental fluid substitution, or catastrophic fluid failure. In addition, regularly timed maintenance intervals can be wasteful if a fluid, with remaining useful life, is prematurely replaced or refreshed. Owners and/or operators can reduce cost with on-line fluid monitoring methods and apparatus that provide substantially “real-time” determination of a fluid's initial quality and a fluid's continuing condition during use to minimize fluid maintenance costs without risking damage or inefficient operation by maintaining a fluid only at or near the end (natural or otherwise) of the fluid's usefulness.

An issue with on-line determination of fluid quality and/or condition is that many measurements of fluid properties used in the determination are a function not only of the fluid's quality/condition, but also the fluid's temperature. In applications where fluid temperature can vary as a function of device/process, internal and/or external operating parameters, it is more difficult to accurately determine the fluid's quality/condition. To illustrate this point, FIG. 1 is an example of an engine oil temperature variation for an on-highway diesel engine during a particular operating cycle. As used herein, an operating cycle is defined as that period from when a device is turned “on” until it is turned “off”, or from when a process is started until the process is completed or shutdown. Ignoring the warm-up period immediately following engine start, FIG. 1 shows that for this operating cycle, the oil temperature varied over a range of approximately 83° C. to 110° C. FIGS. 2 and 3 are exemplary illustrations of diesel-engine-oil's electrical-impedance and viscosity variation respectively over the engine temperature operating range 80° C. to 110° C. at three times in an oil's useful life as determined in laboratory tests used to evaluate oil performance. For both FIGS. 2 and 3, curve A is for a fresh (unused) fluid at the start of the test, curve B is for sample of the same fluid removed from a test engine after approximately 10% of a standard test period, and curve C is for the same fluid drained from the engine at the end of the standard test period. The curves of FIGS. 2 and 3 show that over the oil operating temperature range shown in FIG. 1, the variations due to temperature change are significant relative to the variations due to fluid condition change during the fluid's useful life. Thus, an accurate fluid condition determination using these two properties can only be made if temperature related changes are separated from condition related changes. In general, most measurable properties of any fluid vary as a complex function of temperature and quality/condition.

One approach for separating temperature and quality/condition effects is to maintain a fixed fluid temperature. One or more sensors can be mounted in a temperature controlled manifold or chamber, or individual sensors can have heating and/or cooling elements mounted at— or adjacent to—the “sensing location” to maintain a fixed temperature of the quantity of fluid being “sensed”. Limitations of this approach include added system complexity and added system cost for both hardware and power.

Another approach to separating temperature related effects from fluid property measurements is to collect data only when the fluid temperature is within a determined limited range while in use. Some fluid monitoring algorithms, e.g. the algorithm shown in German published application DE 101 21 186 A1, only collect data at specific temperatures as the fluid's temperature increases after equipment start-up. A limitation of this approach is that there may be long periods of equipment use between data collection, negating the “continuous monitoring” benefit of on-line monitoring.

Another approach to separating temperature related effects from fluid property measurements is to “correct” or compensate the data for temperature variations by using fixed formulae or “look-up” tables. This approach typically assumes that all fluids, current and future, for a particular application have, or will have, the same or very similar temperature related dependences, and that the temperature related dependences do not vary as the fluid condition changes. In general, however, this is limited in that fluids can have different temperature related dependences and, as shown in FIGS. 2 and 3, temperature related dependences can change as a function of fluid condition during use. Hence, this approach can have error.

Another approach to separating temperature related effects from fluid property measurements is to correct the data using formulae or look-up tables determined when the equipment using the fluid is turned “off” at the end of an operating period and the equipment, and therefore the fluid, cools. U.S. Pat. No. 6,509,749 B1 teaches a method of generating a temperature compensation equation for oil used in an internal combustion engine when the engine stops operating and of using the generated equation to calculate an oil condition trend point. A limitation of this approach is that many equipment are not turned “off” often enough to maintain a relatively “current” temperature compensation equation. Another limitation of this approach is that when the equipment is “off” the fluid is not being circulated and the temperature compensation equation is based on one small sample of fluid that may change properties due to separating/settling of various phases in the fluid, or interactions between the static fluid sample and sensor while the equipment and oil cools. Another limitation of this approach is that the rate of cooling, and therefore the cooling period, can vary dramatically based on the operating state of the equipment before being turned “off” and the ambient conditions surrounding the equipment. Another limitation of this approach is that the sensor(s) and controller used to collect the temperature dependent data collecting the data must be “on” while the equipment is “off”. Hence, this approach may not provide appropriate correction for fluid data collected while an equipment operates.

The present invention overcomes limitations of previous approaches for separating data relevant to the quality and/or condition of a fluid in use in a device or process from sensed data that contains temperature related effects. The invention is a simple, cost-effective, accurate method for minimizing temperature related effects on fluid properties that are essentially continuously sensed while the fluid is in use.

### SUMMARY OF THE INVENTION

The present invention is a method to temperature compensate data used in determining one or more properties or conditions of a fluid in use in a device or process that comprises:
a) collecting data when, in use, fluid temperature changes from a first threshold temperature to at least a second threshold temperature at least at a threshold rate;
b) determining the temperature dependence of the collected data; and,
c) using the determined data-temperature-dependence for data temperature compensation.

One invention feature is that data can be collected when the fluid temperature is increasing and the first threshold temperature is less than the second threshold temperature.

Another invention feature is that the data can be collected when the fluid temperature is decreasing and the first threshold temperature is greater than the second threshold temperature.

Another invention feature is that data can be collected either when the fluid temperature is increasing between a first set of first and second threshold temperatures at greater than a first threshold rate, or when fluid temperature is decreasing between a second set of first and second threshold temperatures at greater than a second threshold rate where either the first set and second set of first and second threshold temperatures are either the same or different, and where the first and second threshold rates are either the same or different.

Another invention feature is that the threshold temperatures and threshold rate can be fixed.

Another invention feature is that the method can further comprise determining at least one of the following: threshold temperature and threshold rate.

Another invention feature is that data collection, temperature dependence determination and use of the data-temperature-dependence can occur for a single data series, or can occur for multiple data series.

Another invention feature is that the data collection can continue for fluid temperatures beyond the second threshold temperature if the temperature change rate remains above the threshold rate.

Another invention feature is that data-temperature-dependence can be determined every time the fluid temperature meets the thresholds criteria.

Another invention feature is that data-temperature-dependence can be determined from at most once to many times during each device or equipment operating cycle.

Another invention feature is that information about the determined data-temperature-dependence can be output for use in determining fluid quality and/or condition.

Another invention feature is that the determined data-temperature-dependence can be used to correct data by replacing a current data-temperature-dependence.

Another invention feature is that the determined data-temperature-dependence can be used to correct data by being combined with a current data-temperature-dependence and that combination replacing the current data-temperature-dependence.

Another invention feature is that the determined data-temperature-dependence can not be used to correct data by not replacing a current data-temperature dependence because a property of the determined dependence is not within at least one limit.

Another invention feature is the method can further comprise determining if a data-temperature-dependence is externally inputted, and reading and using such externally inputted data-temperature-dependence for data temperature compensation.

Another invention feature is that an externally inputted data-temperature-dependence can be used to correct data by replacing a current data-temperature-dependence.

Another invention feature is that an externally inputted data-temperature-dependence can be used to correct data by being combined with a current data-temperature-dependence and that combination replacing the current data-temperature-dependence.

Another invention feature is that an externally inputted data-temperature-dependence can not be used to correct data by not replacing a current data-temperature dependence because a property of the externally inputted dependence is not within at least one limit.

Another invention feature is that if a data-temperature-dependence is externally inputted, the method can further comprise receiving, as an input, the portion of fluid with that dependence, and using that input with the externally inputted data-temperature-dependence for data temperature compensation.

### BRIEF DESCRIPTION OF THE FIGURES

FIG. 1 is representative graph illustrating variations in engine oil temperature for an on-highway diesel engine during one operating cycle.

FIG. 2 is representative graph illustrating the temperature dependence of a diesel-engine-oil's electrical-impedance at three times in the engine-oil's useful life.

FIG. 3 is representative graph illustrating the temperature dependence of a diesel-engine-oil's viscosity at three times in the engine-oil's useful life.

FIG. 4 is a flow chart of an invention embodiment that determines data-temperature-dependence when fluid temperature increases.

FIG. 5 is a flow chart of an embodiment of the invention that determines data-temperature-dependence when fluid temperature decreases.

FIG. 6 is a flow chart of an embodiment of the invention that determines data-temperature-dependence when fluid temperature either increases or decreases.

FIG. 7 is a flow chart of another embodiment of the invention that determines data-temperature-dependence.

FIG. 8 is a flow chart of another embodiment of the invention that provides output when a new temperature-dependence is used to temperature compensate data.

FIG. 9 is a flow chart of an embodiment of the invention that combines the determined data-temperature-dependence with the current data-temperature dependence and uses the combined data-temperature-dependence to correct data for temperature variations.

FIG. 10 is a flow chart of an embodiment of the invention that determines data-temperature dependence for two data series at most once each operating cycle.

FIG. 11 is a flow chart of an embodiment of the invention that determines data-temperature dependence with determined threshold temperatures and threshold rate.

FIG. 12 is a flow chart of an embodiment of the invention that outputs information about the determined data-temperature-dependence.

FIG. 13 is a flow chart of an embodiment of the invention that only uses the determined data-temperature-dependence if it is within a preset limit of a current dependence.

FIG. 14 is a flow chart of an embodiment of the invention that allows data-temperature-dependence information to be input to the method.

FIG. 15 is a flow chart of an embodiment of the invention that allows data-temperature-dependence information to be input and combined with the current data-temperature-dependence.

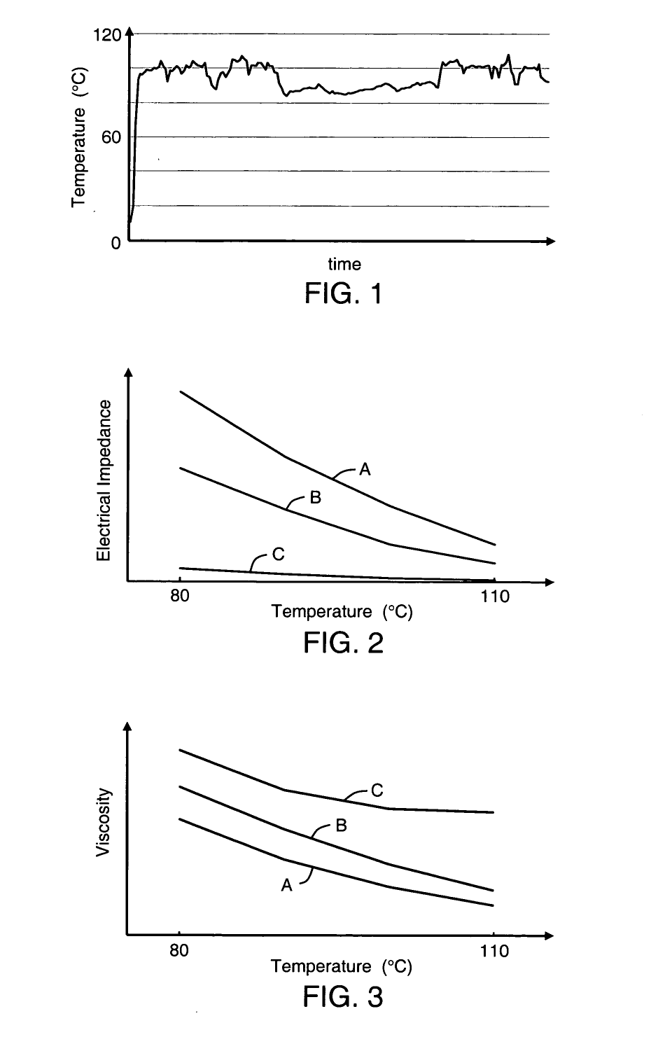

### DETAILED DESCRIPTION OF THE INVENTION

The invention relates to a cost-effective method for compensating data relevant to the quality and/or condition of a fluid while in use in a device or process. For the purposes of illustration, the following figures are shown and described.

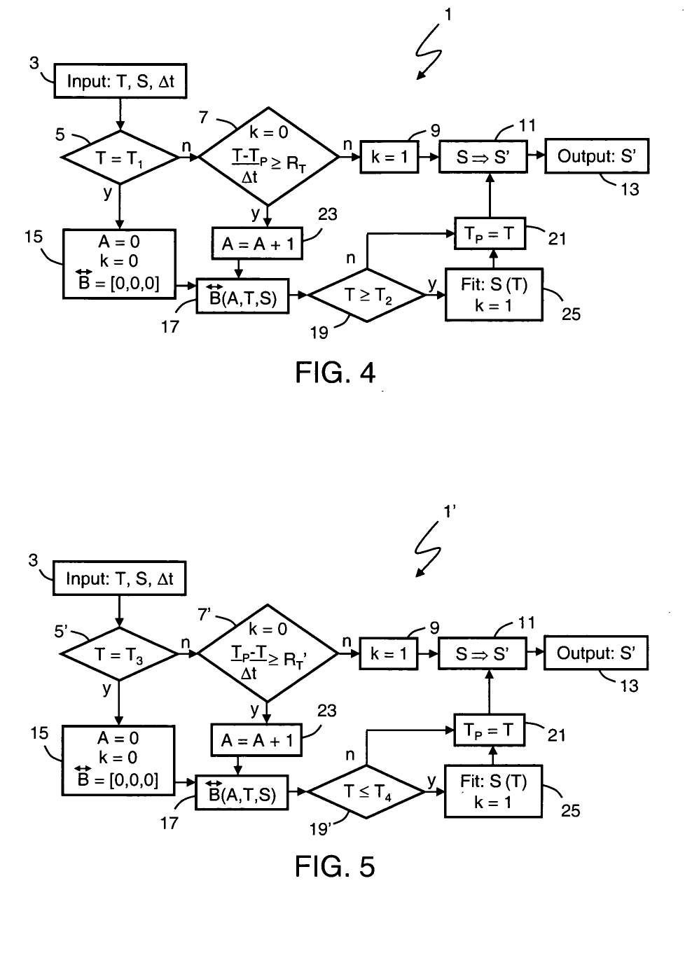

FIG. 4 is a flow chart of an embodiment of the invention for on-line data-temperature-dependence determination of one fluid-data-series in accordance with aspects of the present invention. Method 1 begins at block 3 when the method receives information T, S and Δt from a fluid quality and/or condition determining method (not shown) such as described in co-pending application U.S. Ser. No. 10/271885. T is the temperature or temperature equivalent (i.e. an electronic signal that is a function of the temperature) of the fluid when one or more fluid properties are measured. S is a signal datum that is a function of one or more monitored temperature-dependent fluid properties relevant to fluid quality and/or condition. For examples, S can be the measured electrical impedance or electrical impedance equivalent of the fluid, can be the measured viscosity or viscosity equivalent of the fluid, or can be a function of the measured electrical impedance and measured viscosity. Δt is the time since the previous input of T and S to the method 1. In a case where the device or process using the fluid being monitored was just restarted after an “off” or “shutdown” period, Δt can be the actual time since the last information was inputted to the method, or can be a fixed high-value number to indicate that substantial time has passed since the last information input. With the T, S and Δt information, the method 1 determines in block 5 if temperature T equals a first fixed threshold temperature T₁. If the determination is “no”, the method 1 in block 7 determines if variable k equals zero and if the rate of temperature increase is greater than or equal to a fixed threshold rate R_{T}. In this embodiment the temperature dependence of signal S is determined when fluid temperature increases between first threshold temperature T₁ and a second threshold temperature that is greater than T₁. The rate of temperature increase is determined by the equation (T-T_{P})/Δt, where T and Δt are as described above, and T_{P} is the temperature of the fluid during the previous iteration when signal S as obtained, that is, (T-T_{P})/Δt is the change in temperature between when signals S are measured divided by the time between when the signals are measured; the value being positive with increasing temperature and negative with decreasing temperature. In the case where a device or process was just restarted after an “off” period, Δt will be sufficiently large to assure that the determination in block 7 is “no”. In any case, when the determination of block 7 is “no”, k is set equal to 1 in block 9, and in block 11 the value of S at temperature T is compensated to “standard temperature” value S′, using a current formula or look-up table. That is, the method used to determine the fluid quality and/or condition would prefer that signal S always be taken at a fixed standard-temperature; however, since temperature T may not be at the standard temperature, the signal datum S is temperature corrected in block 11 to a signal S′ based on the current known temperature dependence, S(T) of signal S. The dependence S(T) may be in the form of a formula or a look-up table. The value S′ is the output from the method 1 in block 13.

In the determination of block 5, if temperature T equals the first fixed threshold temperature T₁, then in block 15 the method 1 sets variables A and k equal to zero and all values of matrix B equal to zero. In block 17, columns 2 and 3 of row zero (A=0) of matrix B are set equal to T and S respectively. Method 1 then determines in block 19 whether temperature T is equal or greater than a second fixed threshold temperature T₂, which is greater than threshold temperature T₁. In an iteration where the determination in block 5 was that T equals T₁, the determination in block 19 is “no” and in block 21 previous temperature T_{P} is set equal to T. Method 1 then in block 11 temperature compensates signal S to signal S′ using the current temperature dependence S(T), and in block 13 signal S′ is output for use in a method that determines the quality and/or condition of the fluid being monitored by signal S.

After an iteration of the method 1 where the input temperature T equals first fixed threshold temperature T₁, then in the next iteration where the determination of block 5 is “no”, the method determines in block 7, since k=0 from the previous iteration, if, as described above, the time rate of increase of fluid temperature T is equal to or greater than the fixed threshold rate R_{T}. If the determination is “yes”, in block 23 variable A is increased by one and in block 17, the next row of matrix B has columns 2 and 3 set equal to the current T and S respectively. If block 19 determines that temperature T is not equal or greater than threshold temperature T₂, then T_{P} is set equal to T in block 21, signal S is temperature compensated to signal S′ in block 11 and signal S′ is the method 1 output in block 13.

In subsequent iterations of the method 1, if block 7 continues to determine that k equals zero and the rate of temperature increase remains at or above R_{T}, then temperature T and signal S inputs of block 3 are added to successive rows of matrix B in block 17 as variable A increases by 1 in block 23 with each iteration. This continues until an iteration when T is equal to or greater than the second fixed threshold T₂, as determined in block 19, and in block 25 the method 1 uses temperature T and signal S data in rows zero to A of matrix B to fit, that is determine, a new temperature dependence S(T), either as a function or as a look-up table. Also in block 25, k is set equal to 1. After setting T_{P} equal to T in block 21, the method 1 in block 11 uses the new S(T), which replaces the S(T) used in the previous iteration, to temperature compensate signal S to S′. The resulting S′ is the output of the method 1 in block 13.

When k is set equal to 1 in block 25, or if k is set equal to 1 in block 9 because the rate of temperature increase determined in block 7 drops below fixed threshold R_{T} before a new temperature dependence S(T) is fit in block 25, the method 1 does not begin the process of fitting a new temperature dependence S(T) until the next time block 5 determines that the fluid temperature T input of block 3 is equal to threshold T₁.

In this manner, the method 1 determines a new data S temperature dependence S(T) when fluid temperature increases from a fixed first threshold temperature T₁ to a fixed second threshold temperature T₂ at greater than or equal to fixed threshold temperature rate R_{T}.

In the embodiment of the invention shown in FIG. 4, the data-temperature-dependence is determined when the fluid temperature increases between two threshold temperatures at equal to or greater than a threshold rate. Data-temperature-dependence, however, can also be determined when the fluid temperature decreases between two threshold temperatures at greater than a threshold rate.

FIG. 5 shows a flow chart of another embodiment of the invention. The method 1′ in FIG. 5 has many of the same blocks, which for convenience are numbered the same, as the method 1 shown in FIG. 4. Method 1′ begins at block 3 when the method receives information T, S and Δt (as previously described) from a fluid quality and/or condition determining method (not shown). In block 5, the method 1′ determines if the temperature T equals a first fixed threshold temperature T₃. If the determination is “no”, the method 1′ in block 7′ determines if variable k equals zero and if the rate of temperature decrease is equal or greater than a fixed threshold R_{T}′. In this embodiment the temperature dependence of signal S is determined when fluid temperature decreases between first threshold temperature T₃ and a second threshold temperature that is less than T₃. The rate of temperature decrease is determined by the equation (T_{P}-T)/Δt where, as in the method 1 of FIG. 4, T_{P} is the temperature of the fluid during the previous iteration when signal S was obtained; that is, (T_{P}-T)/Δt is the change in temperature between when signals S are measured divided by the time between when the signals are measured; the value being positive with decreasing temperature and negative with increasing temperature. In the case where a device or process was just restarted after an “off” period, Δt will be sufficiently large to assure that the determination in block 7′ is “no”. In any case, when the determination of block 7′ is “no”, k is set equal to 1 in block 9, in block 11 the value of S at temperature T is compensated to “standard temperature” value S′, using a current formula or look-up table, and value S′ output from method 1′ in block 13.

In the determination of block 5′, if temperature T equals the first fixed threshold temperature T₃, then in block 15 the method 1′ sets variables A and k equal to zero and all values of matrix B equal to zero. In block 17, columns 2 and 3 of row zero (A=0) of matrix B are set equal to T and S respectively. Method 1′ then determines in block 19′ whether temperature T is to equal or less than the second fixed threshold temperature T₄, which is less than threshold temperature T₃. In an iteration where the determination in block 5′ was that T equals T₃, the determination in block 19′ is “no” and in block 21 previous temperature T_{P} is set equal to T. Method 1′ then in block 11 temperature compensates signal S to signal S′ using the current temperature dependence S(T), and in block 13 signal S′ is output for use in a method that determines the quality and/or condition of the fluid being monitored by signal S.

After an iteration of the method 1′ where the input temperature T equals first fixed threshold temperature T₃, then in the next iteration where the determination of block 5′ is “no”, the method determines in block 7′, since k=0 from the previous iteration, if, as described above, the time rate of decrease of fluid temperature T is equal or greater than the fixed threshold rate R_{T}′. If the determination is “yes”, in block 23 variable A is increased by one and in block 17, the next row of matrix B has columns 2 and 3 set equal to the current T and S respectively. If block 19′ determines that temperature T is not equal or less than threshold temperature T₄, then T_{P} is set equal to T in block 21, signal S is temperature compensated to signal S′ in block 11 and signal S′ is the method 1′ output in block 13.

In subsequent iterations of the method 1′, if block 7′ continues to determine that k equals zero and the rate of temperature decrease remains at or above R_{T}, then temperature T and signal S inputs of block 3 are added to successive rows of matrix B in block 17 as variable A increases by 1 in block 23 with each iteration. This continues until an iteration when T is equal to or less than to second fixed threshold T₄, as determined in block 19′, and in block 25 the method 1′ uses temperature T and signal S data in rows zero to A of matrix B to determine a new temperature dependence S(T), either as a function or as a look-up table. Also in block 25, k is set equal to 1. After setting T_{P} equal to T in block 21, the method 1′ in block 11 uses the new S(T), which replaces the S(T) used in the previous iteration, to temperature compensate signal S to S′. The resulting S′ is the output of the method 1′ in block 13.

When k is set equal to 1 in block 25, or if k is set equal to 1 in block 9 because the rate of temperature increase determined in block 7′ drops below fixed threshold R_{T} before a new temperature dependence S(T) is fit in block 25, the method 1 does not begin the process of fitting a new temperature dependence S(T) until the next time block 5′ determines that the fluid temperature T input of block 3 is equal to threshold T₃.

In this manner, the method 1′ determines a new data S temperature dependence S(T) when fluid temperature decreases from a fixed first threshold temperature T₃ to a fixed second threshold temperature T₄ at greater than or equal to the fixed threshold temperature rate R_{T}′.

The embodiment of the invention shown in FIG. 4 determines data-temperature dependence when fluid temperature increases between two threshold temperatures at equal to or greater than a threshold rate, and the embodiment shown in FIG. 5 determines data temperature dependence when fluid temperature decreases between two threshold temperatures at equal to or greater than a threshold rate. The invention, however, allows data-temperature-dependence to be determined either if the fluid temperature increases between two threshold temperatures at equal to or greater than a threshold rate, or fluid temperature decreases between two threshold temperatures at equal to or greater than a threshold rate.

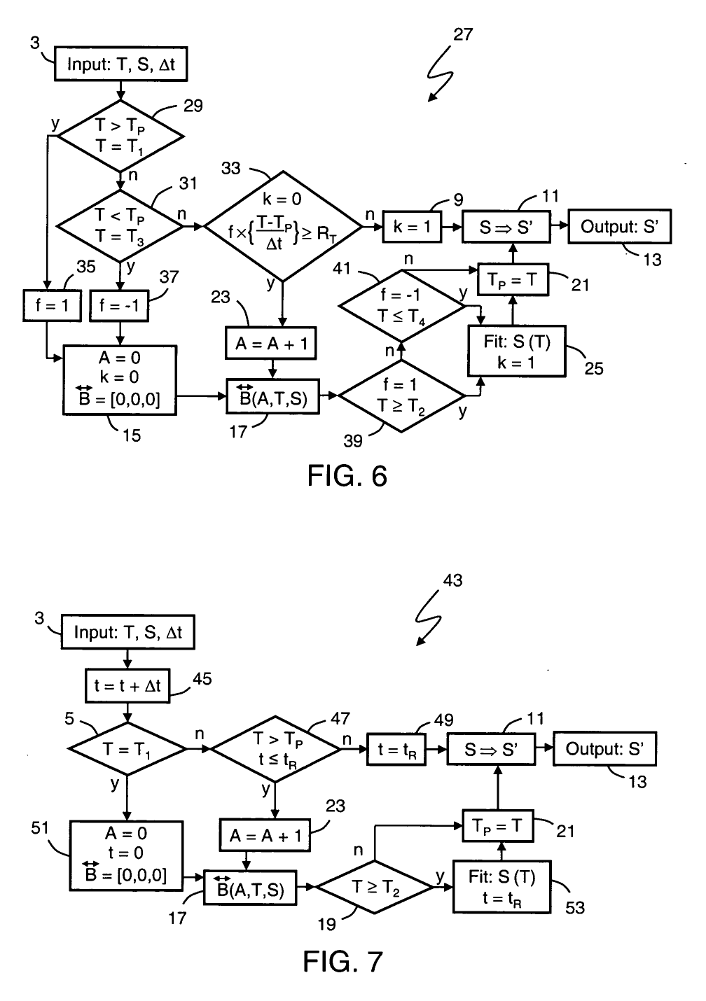

FIG. 6 shows a flow chart of another embodiment of the invention where blocks that are the same as the method 1 of FIG. 4 are labeled the same. Method 27 begins at block 3 when T, S and Δt are received. In block 29, the method 27 determines if temperature T has increased since the previous method iteration and if T is equal to a first increasing threshold temperature T₁. If the determination is “no”, the method 27 in block 31 determines if temperature T has decreased since the previous iteration of the method and if T is equal to a first decreasing threshold temperature T₃. If the determination is “no”, method in block 33 determines if variable k equals zero and if the rate of temperature change is equal or greater than a fixed threshold R_{T}. In this embodiment the rate of temperature change is the quantity fx(T_{P}-T)/Δt, which is the change in temperature between when signals S are measured divided by the time between when the signals are measured, that quantity times a variable f. The variable f will be set such that the temperature change is positive when the fluid temperature is increasing between the increasing threshold temperatures T₁, T₂, and is also positive when the fluid temperature is decreasing between the decreasing threshold temperatures T₃, T₄. In any case where a device or process was just restarted after an “off” period, Δt will be sufficiently large to assure that the determination in block 33 is “no”. In any case, when the determination of block 33 is “no”, k is set equal to 1 in block 9, in block 11 the value of S at temperature T is compensated to “standard temperature” value S′, using a current formula or look-up table, and value S′ output from method 27 in block 13.

In the determination of block 29, if temperature T has increased since the previous iteration and T equals first increasing threshold temperature T₁, then in block 35 the method 27 sets f equal to one. If the determination of block 29 is “no”, but the determination in block 31 is that temperature T has decreased since the previous iteration and T equals first decreasing threshold temperature T₃, then in block 37 the method 27 sets f equal to negative one. In either case, when the temperature is changing in the correct direction and equals a first threshold temperature, the method 27 in block 15 sets variables A and k equal to zero and all values of matrix B equal to zero. In block 17, columns 2 and 3 of row zero (A=0) of matrix B are set equal to T and S respectively. Method 27 then determines in block 39 whether for increasing temperature (f=1) if temperature T is equal to or greater than the second increasing threshold temperature T₂, which is greater than threshold temperature T₁. In an iteration where the determination in block 29 was that T equals T₁ the determination in block 39 is “no”. Method 27 then determines in block 41 whether for decreasing temperature (f=−1) if temperature T is equal to or less than the second fixed threshold temperature T₄, which is less than threshold temperature T₃. In an iteration where the determination in block 31 was that T equals T₃, the determination in block 41 is “no” and in block 21 previous temperature T_{P} is set equal to T. Method 27 then in block 11 temperature compensates signal S to signal S′ using the current temperature dependence S(T), and in block 13 the output of the method is signal S′.

After an iteration of the method 27 where the determination of either block 29 or block 31 is “yes”, then in the next iteration where the determinations of blocks 29, 31 are “no”, the method determines in block 33, since k=0 and the value of f is correctly set in the previous iteration, if the time rate of change of the fluid temperature T is equal to or greater than fixed threshold rate R_{T} which, in this method, is the same threshold whether the change is an increasing temperature or a decreasing temperature. If the determination of block 33 is “yes”, variable A is increased by 1 in block 23 and in block 17 the next row of matrix has columns 2 and 3 set equal to the current T and S respectively. If blocks 39, 41 determine that temperature T is not equal to the appropriate second threshold temperatures, T₂, T₄ respectively, then T_{P} is set equal to T in block 21, signal S is temperature compensated to signal S′ in block 11 and signal S′ is the method 1′ output in block 13.

In subsequent iterations of the method 27, if block 33 continues to determine that k equals zero and the rate of temperature change remains at or above R_{T}, temperature T and signal S inputs of block 3 are added to successive rows of matrix B in block 17 as variable A increases by 1 in block 23 with each iteration. This continues until an iteration when either block 39 or block 41 determines that the temperature T is at or beyond the appropriate second threshold temperature T₂, T₄ respectively, and in block 25 the method 27 uses temperature T and signal S data in rows zero to A of matrix B to determine a new temperature dependence S(T), either as a function or as a look-up table. Also in block 25, k is set equal to 1. After setting T_{P} equal to T in block 21, the method 27 in block 11 uses the new S(T), which replaces the S(T) used in the previous iteration, to temperature compensate signal S to S′. The resulting S′ is the output of the method 27 in block 13.

When k is set equal to 1 in block 25, or if k is set equal to 1 in block 9 because the rate of temperature change determined in block 33 drops below a fixed threshold R_{T} before a new temperature dependence S(T) is fit in block 25, the method 27 does not begin the process of fitting a new temperature dependence S(T) until the next time either block 29 or block 31 determines that the fluid temperature T input of block 3 is changing in an appropriate direction and equals the first threshold temperature T₁ or T₃ respectively.

In this manner, the method 27 determines a new data S temperature dependence S(T) when the fluid temperature either increases from first increasing the threshold temperature T₁ to second increasing the threshold temperature T₂ or decreases from first decreasing the threshold temperature T₃ to second decreasing the threshold temperature T₄ at equal to or greater than threshold temperature rate R_{T}.

Method 27 of FIG. 6 has increasing threshold temperatures T₁, T₂, and decreasing threshold temperatures T₃, T₄. The increasing and decreasing threshold temperatures can cover the same temperature range such that T₁=T₄ and T₂=T₃, or they can cover different temperature ranges such that T₁≠T₄ and/or T₂≠T₃. Also the method 27 has the same threshold rate R_{T} both increasing and decreasing temperature. Other embodiments can have different threshold rates for increasing temperature and decreasing temperature.

Methods 1′ and 27 of FIGS. 5 and 6 show embodiments of the invention where data-temperature-dependence is determined when the fluid temperature decreases from a first threshold temperature to a second threshold temperature at a rate equal to or greater than a threshold rate. For clarity of illustration, the following embodiments of the invention are shown and described only with data-temperature dependence determined for increasing fluid temperature. It is understood that other embodiments can similarly determine data-temperature-dependence for decreasing fluid temperature in lieu of— or in addition to—determining data-temperature-dependence with increasing temperature change.

Methods 1, 1′ and 27 of FIGS. 4, 5, and 6 respectively determine the rate of temperature increase in blocks 7, 7′ and 33 respectively, with each iteration of the method, so that the change in temperature between iterations of the method divided by the time between iterations is equal to or greater than the temperature rate R_{T}. Other embodiments, however, are not limited to determining rate in this manner, with the following embodiment being one example of another way to determine the rate.

FIG. 7 is a flow chart of one embodiment for on-line data-temperature dependence determination of one fluid-data-series. The method 43 of FIG. 7 has many of the same blocks, which for convenience are numbered the same, as method 1 of FIG. 4. Method 43 begins at block 3 where the method receives inputs T, S and Δt. Method 43 in block 45 increases variable t by Δt, and in block 5 determines if input temperature T equals a first threshold temperature T₁. If the determination is “no”, the method 43 in block 47 determines if T is greater than the previous iteration temperature T_{P} and if variable t is equal to or less than a fixed time t_{R}. Time t_{R} is a direct function of the fixed threshold rate R_{T} of method 1 in FIG. 4 such that t_{R} equals the second fixed threshold temperature T₂ minus the first fixed threshold temperature T₁, that quantity divided by the threshold rate R_{T}[t_{R}=(T₂-T₁)/R_{T}]. That is, t_{R} is the time required for the temperature T to increase from T₁ to T₂ at an average rate R_{T}. In the case where a device or process was just restarted after an “off” period, Δt will be sufficiently large to assure that t in the determination in block 47 is “no”. In any case, when the determination of block 47 is “no”, the method 43 in block 49 sets t equal to Δt, and in block 11 the value of S taken at temperature T is temperature corrected to value S′, using a current formula or look-up table. In block 13 the value S′ is the output of method 43.

If the determination of block 5 is that the temperature T equals the first fixed threshold T₁, then in block 51 the method 43 sets variables A, t and all values of matrix B equal to zero. In block 17, columns 2 and 3 of row zero of matrix B are set equal to T and S respectively. In block 19, the method 43 determines whether temperature T is greater than a second fixed threshold temperature T₂. In an iteration where the determination in block 5 was that T equals T₁, the determination in block 19 is “no”, and in block 21 previous temperature T_{P} is set equal to T. Method 43 then in block 11 temperature compensates signal S to signal S′ using the current temperature dependence, and in block 13 signal S′ is the output of the method.

After an iteration of the method 43 where input temperature T equals first fixed threshold temperature T₁, the next iteration where the input temperature T is determined in block 5 to not equal T₁, with t equal to suitably small Δt, the method 43 determines in block 47 if the new temperature T is greater than the temperature of the previous iteration T_{P}. That is, the method 43 determines if the temperature is increasing. If the determination is “yes”, in block 23 variable A is increased by one and in block 17, the next row of matrix B has columns 2 and 3 set equal to the current T and S respectively. If block 19 determines that that temperature T is not equal to or greater than threshold temperature T₂, then T_{P} is set equal to T in block 21, signal S is temperature compensated to signal S′ in block 11 and signal S′ is output from the method 43 in block 13.

In subsequent iterations of the method 43, if block 47 continues to determine that the temperature is increasing and t remains equal to or less than the rate determining time t_{R}, then temperature T and signal S inputs of block 3 are added to successive rows of matrix B in block 17 as A increases by 1 in block 23 with each iteration. This continues until an iteration when T is equal to or greater than the second fixed threshold T₂, as determined in block 19, and in block 53 the method 43 uses the temperature T and the signal S data of rows zero to A of matrix B to fit a new temperature dependence S(T), either as a function or a look-up table, and sets t equal to t_{R}. After setting T_{P} equal to T in block 21, the method 43 in block 11 uses the new S(T), which replaces the S(T) used in the previous iteration, to temperature compensate signal S to S′, and the resulting S′ is the output of method 43 in block 13.

When t is set equal to t_{R} in block 53, or if t is set equal to t_{R} in block 49, because the temperature does not continue to increase or t exceeds t_{R} before a new temperature dependence S(T) is determined in block 53, the method 43 does not begin the process of fitting a new temperature dependence S(t) until the next time block 5 determines that the fluid temperature T input of block 3 is equal to threshold T₁. In this manner, the method 43 determines a new data S temperature dependence S(T) when the fluid temperature increases from a fixed first threshold temperature T₁ to a fixed second threshold temperature T₂ at greater than or equal to a fixed threshold temperature rate determined by the time t_{R}.

Methods 1, 1′, 27, 43 of FIGS. 4, 5, 6, 7 respectively terminate collecting data and determining temperature dependence S(T) once the fluid temperature first equals or exceeds a second threshold temperature. Other embodiments, however, are not limited to terminating the collection of data for determination of temperature dependence once the fluid temperature equals or exceeds a second threshold temperature if the rate of temperature change equals or exceeds the threshold rate. Also methods 1, 1′, 27, 43 do not give output to indicate when a new temperature dependence replaces the current temperature dependence. Other embodiments can give an output to notify when a new temperature dependence is used to compensate signal S.

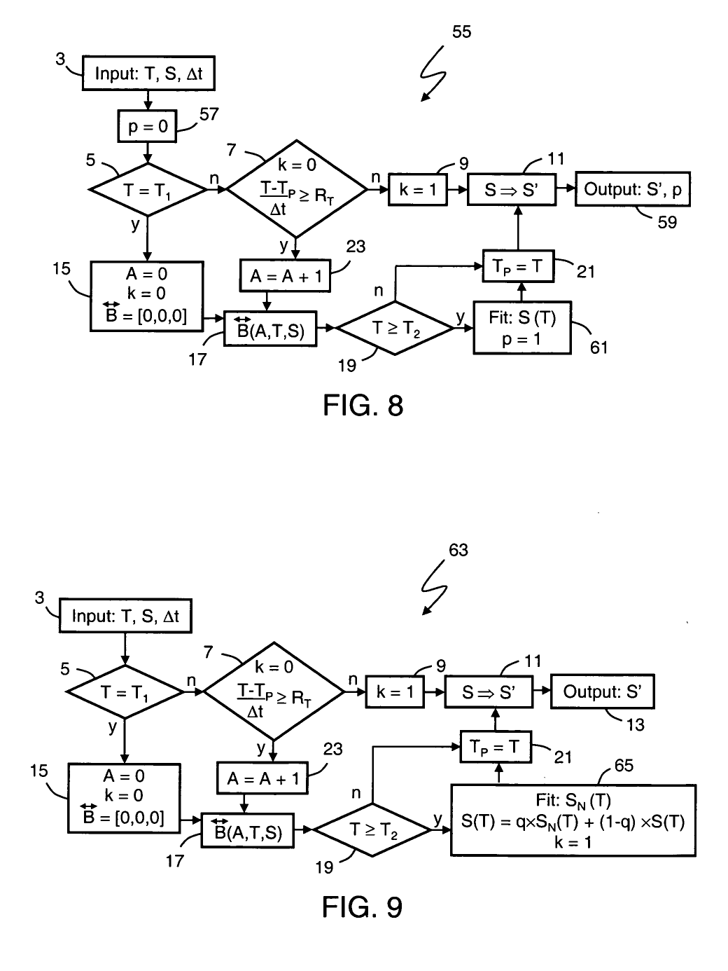

FIG. 8 is a flow chart of another embodiment of the invention. The method 55 of FIG. 8 has many of the same blocks, which are numbered the same, as method 1 of FIG. 4. Method 55 begins when T, S and Δt are received in block 3. In block 57, variable p is set equal to zero. Blocks 5, 7, 9, 11 are the same as described for method 1 of FIG. 4, and the output of method 55 in block 59 is temperature-corrected-signal S′ and variable p.

For iterations of the method 55 when block 5 determines that temperature T equals the first fixed threshold T₁, and after T equals T₁, when block 7 determines that k equals 0 and the temperature increase is equal or greater than threshold rate R_{T}, blocks 15, 17, 19, 21, 23 are the same as described for method 1 of FIG. 4. When method 55 in block 19 determines that T is greater than or equal to threshold T₂, in block 61 T and S data from rows zero to A of matrix B are used to fit a new temperature dependence S(T), and p is set equal to 1. After setting T_{P} equal to T in block 21, the method 55 in block 11 uses the new S(T), which replaces the S(T) used in the previous iteration, to temperature compensate signal S to S′. The resulting S′ and p, which was set equal to 1 in block 61, are the output of the method 55 in block 13. Since p is only equal 1 when a new temperature dependence is used to compensate the output signal, then a fluid quality and/or condition determination the method (not shown) receiving the output of block 59 can, when p=1, determine if a change in signal is due to a fluid change or to a change in temperature compensation.

Since, in this embodiment, k is not set equal to 1 in block 61, the method 55 continues to fit new temperature dependence S(T) for additional iterations after the iteration where block 19 first determines that T is equal to or greater than T₂, as long as the rate of the temperature increase is greater than or equal to rate R_{T}. That is, the method 55 can continue to collect data and determine the temperature dependence of signal S for a temperature range that extends beyond threshold T₂ for iterations where block 7 determines the fluid temperature increase remains equal to or greater than rate R_{T}.

In this manner, the method 55 determines a new data S temperature dependence S(T) when the fluid temperature increases from a first threshold temperature T₁, to at least a second threshold temperature T₂ at greater than a threshold rate R_{T}, and provides output when a new temperature-dependence is used to temperature compensate data.

While the method 55 continues to determine and replace current temperature dependence with a new temperature dependence in each iteration where, for k=0, fluid temperature continues to increase at rate greater than or equal to R_{T} above temperature T₂, other embodiments can, each time k=0, determine and replace current temperature dependence only once. In one embodiment, for example, can when k=0 determine and replace current data-temperature dependence during the iteration when, for T greater than T₂, the temperature change rate is first no longer equal to or greater than threshold rate R_{T} using the data in matrix B from the previous iteration of the method.

Methods 1, 1′, 27, 43, 55 of FIGS. 4, 5, 6, 7, 8 respectively replace the current data-temperature-dependence S(T) each time a new data-temperature-dependence is determined when fluid temperature changes from a threshold temperature to at least a second threshold temperature at greater than a threshold rate. Other embodiments can replace the current data-temperature-dependence with a temperature dependence that is a function of the current temperature dependence and the determined temperature dependence.

FIG. 9 is a flow chart of another embodiment of the invention. Method 63 has blocks 3, 5, 7, 9, 11, 13, 15, 17, 19, 21, and 23 the same as method 1 of FIG. 4. Only block 65 of the method 63 and block 25 of the method 1 are different. In method 63, when data are collected in matrix B as fluid temperature T increases from a first threshold temperature T₁ to equal or greater than a second threshold temperature a temperature T₂ at a rate of at least threshold rate R_{T}, the method in block 65 fits, that is determines, a data-temperature-dependence S_{N}(T), and replaces the current data-temperature-dependence S(T) with fixed variable q times the current temperature dependence plus (1-q) times the determined temperature-dependence SN(T). The variable q is a number greater than zero and less than 1. The variable k is also set equal to one in block 65 or the method 63.

In this manner, the current data-temperature-dependence S(T) of the method 63 is replaced with the function of the current dependence and a determined temperature dependence that allows an effective averaging of the determined temperature dependences.

While the method 63 of FIG. 9 has a linear function combining the current data-temperature-dependence with the determined temperature dependence, other embodiments can have other functions, such as a quadratic function for combining the temperature dependences.

Methods 1, 1′, 27, 43, 55, 63 of FIGS. 4, 5, 6, 7, 8, 9 respectively determine the temperature dependence of a single signal S(T). Other embodiments can determine the temperature dependence of multiple signals. Also methods 11, 1′, 27, 43, 55, 63 begin the process of collecting data and determining a data-temperature-dependence every time input temperature T equals the first fixed threshold temperature T₁. Other embodiments are not limited to beginning the process of collecting data and determining temperature dependence every time T equals T₁.

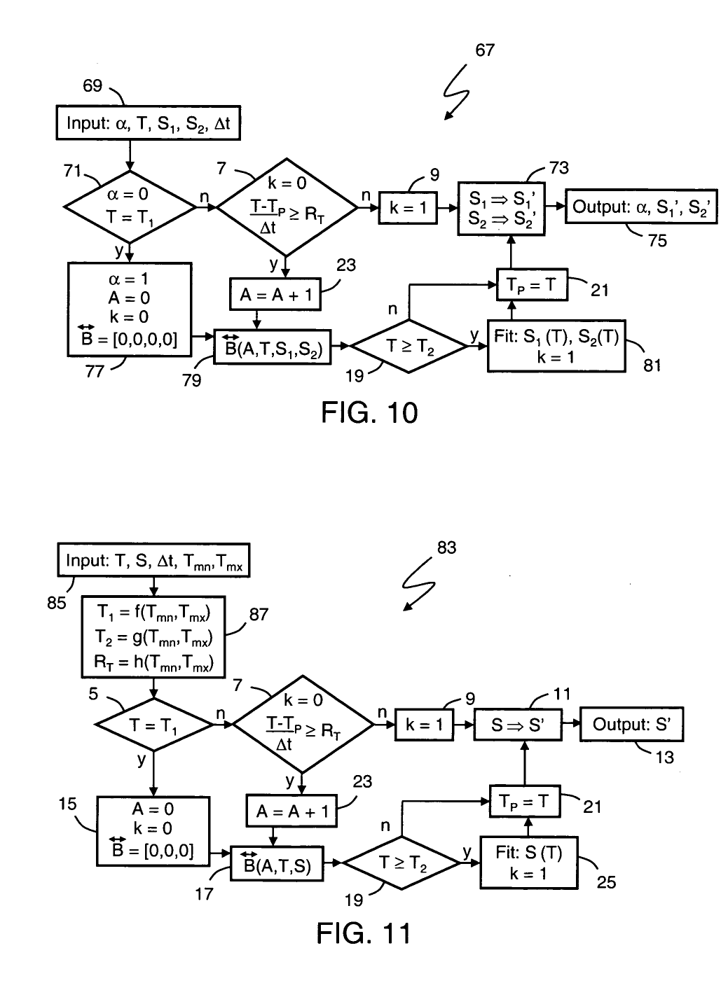

FIG. 10 is a flow chart of another embodiment of the invention. Method 67 has many blocks the same as method 1 of FIG. 4, which are numbered the same. Method 67 begins at block 69 when the method receives α, T, S₁, S₂ and Δt from a fluid quality and/or condition determining method (not shown). Variable α is reset to equal zero (external to method 67 and not shown) each time the device or process with the monitored fluid, is turned “on” to begin an operating cycle. T and Δt are the same as described in the method 1 of FIG. 4. S₁ and S₂ are each, typically independent, signal datum that is a function of one or more monitored temperature-dependent fluid properties relevant to fluid quality and/or condition. For example, S₁ can be the sensed electrical impedance or electrical impedance equivalent of the fluid, and S₂ can be the sensed viscosity or viscosity equivalent of the fluid. In block 71, the method 47 determines if α equals zero and if temperature T equals a first threshold temperature T₁. If the determination is “no”, the method 67 in block 7 determines if variable k equals zero and the rate of the fluid temperature increase is equal to or greater than threshold rate R_{T}. If the determination of block 7 is “no”, in block 9, k is set equal to 1, and in block 53 S₁, S₂ at temperature T are compensated to “standard temperature” value S₁′, S₂′ respectively using current formulae or look-up tables S₁(T) and S₂(T). The values α, S₁′ and S₂′ are the output from method 67 in block 75.

For a first iteration of the method 67 where block 71 determines that T equals the first threshold temperature T₁, then in block 77, α is set equal to 1, and A, k and all values of matrix B are set equal to zero. In block 79, columns 2, 3 and 4 of row zero (A=0) of matrix B are set equal to T, S₁ and S₂ respectively. Method 67 then determines in block 19 whether temperature T is greater than a second threshold temperature T₂. In an iteration where block 71 determined that T equals T₁, the determination in block 19 is “no”, and in block 21 previous temperature T_{P} is set equal to T. Method 67 then in block 73 temperature corrects signals S₁, S₂ to signals S₁′, S₂′ respectively using the current temperature dependences S₁(T), S₂(T) respectively, and in block 75 α and signals S₁′, S₂′ are the output from the method 67.

After an iteration of the method 67 where the input temperature T equals first threshold temperature T₁, in the next iteration the determination of block 71 is “no” since α is not equal to zero, the method determines in block 7, since k=0 from the previous iteration, if temperature T is increasing at a rate equal to or greater than threshold rate R_{T}. If the determination is “yes”, in block 23 A is increased by one and in block 79, the next row of matrix B has columns 2, 3, 4 set equal to the current T, S₁, S₂ respectively. If block 19 determines that that temperature T is not greater than threshold temperature T₂, then T_{P} is set equal to T in block 21, signals S₁, S₂ are temperature compensated to signals S₁′, S₂′ respectively in block 11 and α and signals S₁′, S₂′ are the output of the method 67 in block 75.

In subsequent iterations of the method 67, if block 7 determines that k equals zero and the rate of temperature increase is not less than R_{T}, temperature T and signals S₁, S₂ inputs of block 3 are added to successive rows of matrix B in block 79 as variable A increases by 1 in block 23 with each iteration. This continues until an iteration when T is equal to or greater than second fixed threshold T₂, as determined in block 19, and in block 81 the method 67 uses temperature T and signal S₁ data in rows zero to A of matrix B to fit a new temperature dependence S₁(T), either as a function or a look-up table, and similarly uses temperature T and signal S₂ data in rows zero to A of matrix B to fit a new temperature dependence S₂(T), either as a function or a look-up table data. Also in block 81, k is set equal to 1. After setting T_{P} equal to T in block 21, the method 67 in block 73 uses the new S₁(T), which replaces the S₁(T) used in the previous iteration of the method 67, to compensate signal S₁ to S₁′, and uses the new S₂(T), which replaces the S₂(T) used in the previous iteration of the method 67, to compensate signal S₂ to S₂′. Variable α and the resulting S₁′, S₂′ are the output of method 67 in block 75.

When k is set equal to 1 in block 81, or if k is set equal to 1 in block 9 because the rate of temperature increase determined in block 7 drops below fixed threshold R_{T} before new temperature dependences S₁(T), S₂(T) are fit in block 81, the method 67 can not begin the process of fitting new temperature dependences S₁(T), S₂(T) until the device or process with the fluid being monitored is turned “off” and again turned “on” resetting α equal to zero, and block 5 determines that the fluid temperature T input of block 69 is equal to threshold T₁.

In this manner, the method 67 determines a new data S₁, S₂ temperature dependences S₁(T), S₂(T) respectively, when fluid temperature increases from the first threshold temperature T₁ to the fixed second threshold temperature T₂ at greater than or equal to fixed threshold temperature rate R_{T}, at most once during each operating cycle of the device or process containing a fluid being monitored.

While the method 67 determines the temperature dependence of two signals, other embodiments of the invention can determine the temperature dependence for greater than two signals.

The embodiments shown by the flow charts of FIGS. 4-10 have fixed threshold temperatures and fixed threshold temperature rate. Other embodiments of the invention can have threshold temperatures and/or threshold rates that are not fixed.

FIG. 11 is a flow chart of another embodiment of the invention. Method 83 has many blocks the same as the method 1 of FIG. 4, which for convenience are numbered the same. Method 83 begins at block 85 when the method receives information T, S, Δt, Tₘₙ and Tₘₓ from a fluid quality and/or condition determining method (not shown). T, S and Δt are same as described in method 1 of FIG. 4. Tₘₙ is the minimum fluid temperature monitored by the fluid quality and/or condition determining method during the previous operating cycle. That is, during the last complete period from the time that the device or process containing the fluid was turned “on” or started until the device or process was turned “off” or shutdown, Tₘₙ was the lowest fluid temperature recorded. Similarly, Tₘₓ is the maximum fluid temperature recorded during the previous operating cycle. Tₘₙ and Tₘₓ are typically dependent on variables such as ambient conditions, duty cycle and loading, operating period, operator inputs or other internal and external conditions. In block 87, method 83 determines threshold temperature T₁, threshold temperature T₂ and threshold rate R_{T} with functions f(Tₘₙ, Tₘₓ), g(Tₘₙ, Tₘₓ) and h(Tₘₙ, Tₘₓ) respectively. Since the temperatures Tₘₙ, Tₘₓ are based on the previous equipment operating period, the thresholds calculated in block 87 of method 83, do not change during the present operating cycle. That is, the thresholds remain fixed for the current operating cycle, but can vary between operating cycles. After the thresholds are determined in block 87 the remaining blocks, block 5-25 are the same as method 1 of FIG. 4 and the output S′ is determined in the same manner.

While method 83 determines the threshold temperatures and threshold rate as a function of Tₘₙ, Tₘₓ from the previous device or process operating cycle, other embodiments can determine thresholds as a function of additional or other fluid or non-fluid variables that are monitored or input during either previous or current operating cycles. Also while the thresholds determined by the method 83 are fixed during the current operating period, other embodiments can have thresholds that vary based on fluid variables monitored or other inputs made during the current equipment operating cycle.

None of the previous embodiments of the invention shown by the flow charts of FIGS. 4-11 outputs specific information about the determined data-temperature-dependence(s) that might be useful to a method that determines quality and/or condition of a fluid or for other purposes. Other embodiments of the invention can output information about determined data-temperature-dependence(s) such as shown in the following figure.

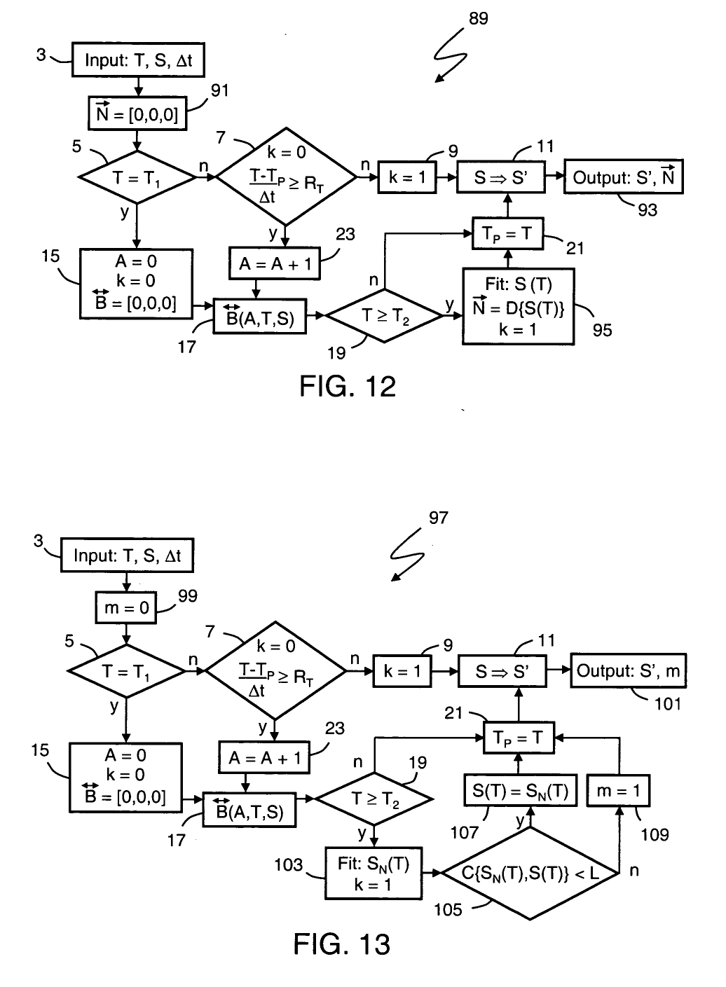

FIG. 12 is a flow chart of another embodiment of the invention. Method 89 has many of the same blocks, which for convenience are numbered the same, as the method 1 of FIG. 4. Method 89 begins at block 3 where the method receives T, S, Δt from a fluid quality and/or condition determining method (not shown). In block 91, a three-dimension vector N has all values set equal to zero. Blocks 5, 7, 9, 11 are the same as described for the method 1 of FIG. 4 and the output of method 89 in block 93 is temperature corrected signal S′ and vector N.

When block 5 of the method 89 determines that temperature T equals first threshold T₁, or, after T equals T₁, when block 7 determines that variable k equals 0 and the temperature increase is greater than or equal to the threshold rate R_{T}, blocks 15, 17, 19, 21, 23 are the same as described for the method 1 of FIG. 4. When the method 89 in block 19 determines that T is greater than or equal to threshold T₂, in block 95 T and S data in rows zero to A of matrix B are used to fit new temperature dependence S (T) and vector N is determined using function D{S(T)}. Vector N contains information about S(T), for example, slope, intercept and R² fit to the data that can be relevant to determining quality and/or condition of a fluid. Also in block 95, k is set equal to 1. Method 89 sets T_{P} equal to T in block 21, and in block 11 use the new S(T) to temperature compensate signal S to signal S′. The temperature compensated signal S″ and vector N are then output from the method 89 in block 93.

In this manner, the method 89 replaces the current temperature dependence S(T) with a determined dependence and provides a vector output with information about the temperature dependence when the fluid temperature increases from a first threshold temperature T₁ to a second threshold temperature T₂ at rate equal to or greater than rate R_{T}.

The embodiments of the invention shown in FIGS. 4-12 replace a current data-temperature-dependence each time a new dependence is fitted. Other embodiments of the invention can replace a current data-temperature-dependence only if a determined dependence meets criteria such as shown in the following figure.

FIG. 13 is a flow chart of another embodiment of the invention. Method 97 has many of the same blocks, which are numbered the same, as method 1 of FIG. 4. Method 97 begins at block 3 where the method receives T, S, Δt information. In block 99 variable m is set equal to zero. Blocks 5, 7, 9, 11 are the same as described for the method 1 of FIG. 4 and the output of method 97 in block 101 is temperature corrected signal S″ and variable m.

For iterations of method 97 when block 5 determines that temperature T equals the first threshold temperature T₁, or, after T equals T₁, when block 7 determines that variable k equals 0 and the temperature increase if equal to or greater than threshold rate R_{T}, blocks 15, 17, 19, 21, 23 are the same as described for the method 1 of FIG. 4. When the method 97 in block 19 determines that T is equal to or greater than threshold temperature T₂, in block 103 T and S data in rows zero to A of matrix B are used to fit a new temperature dependence S_{N}(T), and k is set equal to 1. In block 105 the new temperature dependence S_{N}(T) is compared to the current temperature dependence S(T) in function C{S_{N}(T),S(T)}, which calculates differences between the two dependences using, for example, slope and/or intercept, to determine a single numerical value. If block 105 determines that the difference calculated by C{S_{N}(T),S(T)} is less than fixed value L, then in block 107 the current temperature dependence S(T) is replaced with a new temperature dependence S_{N}(T), T_{P} is set equal to T in block 21, and the new S(T) is used to temperature compensate signal S to signal S″ in block 11 before S″ and m, which is equal to zero, are output from the method 97 output in block 101. If block 105 determines that the difference calculated by C{S_{N}(T),S(T)} is not less than L, then m is set equal to 1 in block 109, T_{P} is set equal to T in block 21, and the current S(T) is used to temperature compensate signal S to signal S″ in block 11 before S″ and m, which is equal to one, are output from the method 97 in block 101.

In this manner, the method 97 only replaces the current temperature dependence S(T) with a new dependence S_{N}(T), determined when fluid temperature increases from first threshold temperature T₁ to at least a second fixed threshold temperature T₂ at a rate equal or greater than rate R_{T}, only if the comparison function C{S_{N}(T),S(T)} is less than a fixed limit L. Further, method 97 outputs m equal to 1 in block 101 when a determined temperature dependence S_{N}(T), is not within the fixed limit of the current temperature dependence S(T).

While function C{S_{N}(T),S(T)} of the method 97 has a scalar output, that is a single numerical value, that is compared to scalar L, other embodiments can have a non-scalar output, for example a vector output, that has multiple values, for example slope difference, intercept difference and others, that are compared to limits for each of the multiple values. Further other embodiments can have a variable, such as variable m of the method 67 of FIG. 10, for each of multiple outputs of the comparison functions that are output from the method to indicate which, if any, of the outputs of the comparison function are not within the comparison limits.

While the embodiment of the method 97 determines temperature dependence S_{N}(T) and determines a comparison to the current temperature dependence S(T) for a single signal S, other embodiments can determine temperature dependence and determine comparisons to current temperature dependence for a multitude of signals. Embodiments can allow individual temperature dependences to replace current temperature dependences based on individual comparison functions and can have output(s) for each comparison, or can accept or reject replacement of all temperature dependences based on a combined comparison function and have method output(s) of the combined comparison.

While the embodiment of method 97 determines whether to replace the current temperature dependence S(T) with a new temperature dependence S_{N}(T) by comparing the two temperature dependences, another embodiment can make the replacement determination based on properties only of the new temperature dependence S_{N}(T), with no comparison to the current temperature dependence. That is, an embodiment similar to method 97 can have a function E{S_{N}(T)} in a block similar to 105 that calculates one or more properties of the determined S_{N}(T), for example, the R² of the fit of S_{N}(T) to the temperature and signal data of matrix B, and determines if that property(s) is within a limit; where in the example the current temperature dependence would only be replaced block 107 if the R² of the determined temperature dependence is greater than a fixed value.

The embodiments of FIGS. 4-13 use only data-temperature-dependence determined by the method in the replacement of the current data-temperature-dependence. Other embodiments can also use externally inputted data-temperature-dependence information such as shown in the following figure to replace the current data-temperature-dependence.

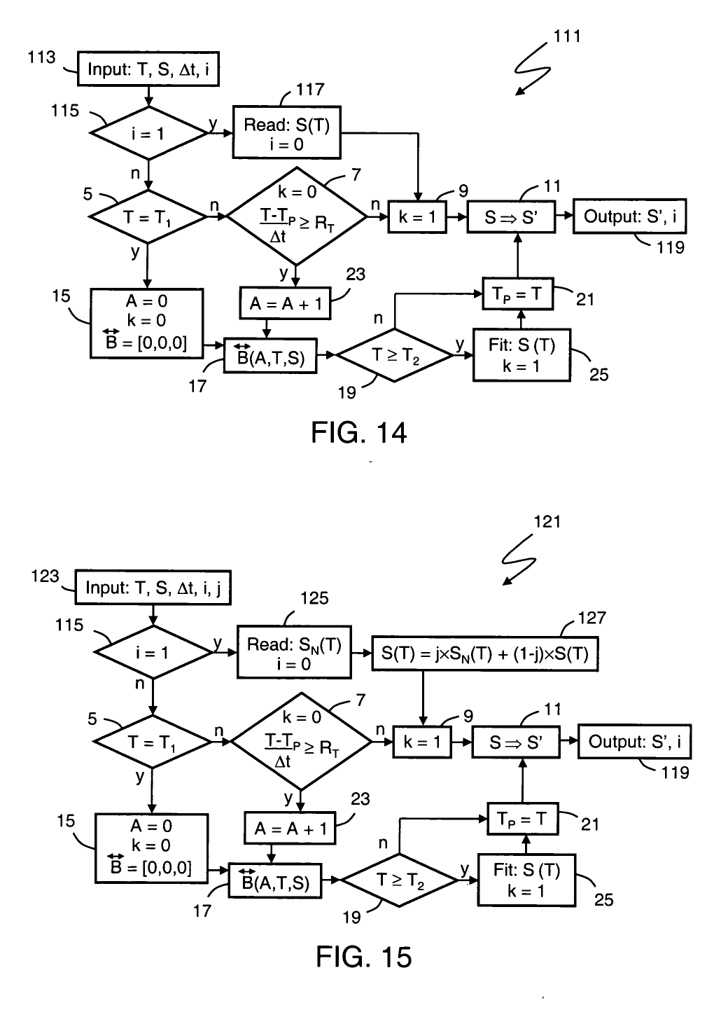

FIG. 14 is a flow chart of another embodiment of the invention. Method 111 has many of the same blocks, which are numbered the same, as method 1 of FIG. 4. Method 111 begins at block 113 where the method receives T, S, Δt and variable i information. T, S, Δt are the same as previously described. Variable i is a signal that indicates when a new temperature dependence S(T) is input to the method by some automatic or manual means. When i equals zero a new temperature dependence was not input since the previous iteration of method 111, and when i equals one a new temperature dependence was input since the previous iteration. An example of when a new temperature dependence may be automatically or manually entered is during a device or process fluid change; i.e. when the fluid being monitored is replaced with a new or fresh fluid since the last iteration of method 111. In block 115, method 111 determines if i equals one. If the determination is “no”, then blocks 5, 7, 9, 11 15, 17, 19, 21, 23, 25 are the same as described for method 1 of FIG. 4 and the output of method 111 in block 95 is temperature corrected signal S′ and i. If the determination in block 115 is “yes”, then in block 117 method 111 replaces the current data-temperature-dependence with a data-temperature-dependence S(T) that was input by automatic or manual means, and sets i equal to zero to indicate that the new temperature dependence was read. Method 111 then set k equal to 1 in block 9, uses the data-temperature-dependence of block 117 to temperature correct data S in block 11 and outputs the corrected signal S′ and i, which equals zero, in block 119. Subsequent iterations of method 111 continue to use the data-temperature-dependence read in block 117 until that dependence is replaced by a data-temperature-dependence S(T) determined in block 25 or until the i input of block 113 is equal to 1 and a new S(T) is read in block 117.

In this manner, in addition to current data-temperature-dependence being replaced by a temperature dependence determined by the method 111, the current data-temperature-dependence can be replaced by a temperature dependence that is externally input, either automatically or manually, to the method 111.

While the method 111 of FIG. 14 replaces the current data-temperature-dependence with the externally inputted data-temperature-dependence without determining any properties of the inputted dependence, other embodiment can read the externally inputted dependence as S_{N}(T) and as in block 105 of embodiment-97 of FIG. 13 determine if S_{N}(T) is within limits before replacing the current data-temperature-dependence. The addition of determining if the externally inputted dependence is within limits could be used to check that the data-temperature-dependence is not incorrectly entered and/or incorrectly read.

Method 111 of FIG. 14 totally replaces the current data-temperature-dependence with the externally inputted data-temperature-dependence. In another embodiment, the method can replace the current temperature dependence with a temperature dependence that is a function of an externally inputted temperature dependence and the current temperature dependence.

FIG. 15 is flow chart of another embodiment of the invention. Method 121 has many of the same blocks, which are numbered the same, as method 111 of FIG. 14. Method 121 begins with block 123 where the method receives T, S, Δt, i and variable j information. T, S, Δt, i are the same as previously described. Variable j is a signal, with value from zero to one, that quantifies the portion of the fluid in the device or process with a new temperature dependence S(T). As an example, a data-temperature-dependence can be automatically or manually entered and i set equal to one when a fresh fluid is used to “top-off” or replace a portion of the fluid being monitored in a device or process, and a value for j can be entered indicating the portion of fluid that is now fresh. If the fresh fluid is now, for example, 50% of the fluid in the device or process, j would equal 0.5. In block 115, the method 121 determines if i equals one. If the determination is “no”, then blocks 5, 7, 9, 11 15, 17, 19, 21, 23, 25 are the same as described for method 1 of FIG. 4 and the output of method 121 in block 119 is temperature corrected signal S′ and i. If the determination in block 115 is “yes”, then in block 125 method 121 reads new temperature dependence S_{N}(T), and sets i equal to zero to indicate that the new temperature dependence was read. In block 127 method 121 replaces the current data-temperature-dependence with j times the new temperature dependence plus one minus j times the current temperature dependence. That is, the data-temperature-dependence is replaced by that portion of fluid which is new times the temperature dependence of the new fluid plus the remaining portion of current fluid times the current temperature dependence. Method 121 then sets k equal to 1 in block 9, uses the data-temperature-dependence calculated in block 127 to temperature correct data S in block 11 and outputs the corrected signal S′ and i, which equals zero, in block 119. Subsequent iterations of method 121 continue to use the data-temperature-dependence calculated in block 105 until that dependence is replaced by a temperature dependence S(T) determined in block 25 or until the i input of block 113 is equal to 1, a new S_{N}(T) is read in block 125, and a replacement S(T) is calculated in block 127.

In this manner, in addition to current temperature dependence being replaced by a temperature dependence determined by method 121, the current data-temperature-dependence can be replaced by a temperature dependence that is a function of an externally input temperature dependence and the current temperature dependence.

While the method 121 uses a linear function in block 127 to combine the temperature dependence of the new fluid with the temperature dependence of the current fluid, other embodiments of the present invention can use other functions to combine the temperature dependences of the new and current fluids.

While particular embodiments of the present invention have been shown and described, it is apparent that various combinations, changes and modification may be made therein to meet data-temperature-compensation needs of various applications without departing from the invention in its broadest aspects. In particular, with regard to various functions performed by the above described invention, the terms (including any reference to a “means”) used to describe individual inputs to or use of outputs from the invention are intended to correspond, unless otherwise indicated, to any method, component or sub-system which performs the specified function providing the particular input(s) or receiving the particular output(s). In addition, while a particular feature of the invention may have been disclosed with respect to only one of several embodiments, such feature may be combined with one or more other features of the other embodiments as may be desired and advantageous for any given or particular application.

1. A method to temperature compensate data of a fluid while in use that comprises:
a) collecting data when fluid temperature changes from a first threshold temperature to at least a second threshold temperature at least at a threshold rate;
b) determining the temperature dependence of the collected data; and,
c) using the determined data-temperature-dependence for temperature compensating data of the fluid's condition.

2. (canceled)

3. (canceled)

4. (canceled)

5. The method of claim 1 wherein the method further comprises determining at least one of the following selected from the group consisting of: threshold temperature, threshold rate or combinations thereof.

6. (canceled)

7. (canceled)

8. (canceled)

9. (canceled)

10. (canceled)

11. (canceled)

12. The method of claim 1 wherein a property of the determined data-temperature-dependence not being within at least one property is selected from the group consisting of: the determined data-temperature-dependence alone; a function of the determined data-temperature-dependence and the current data-temperature-dependence and combinations thereof.

13. (canceled)

14. (canceled

15. (canceled)

16. (canceled)

17. (canceled)

18. (canceled)
